(19) United States
(12) Patent Application Publication
(10) Pub. No.: US 2008/0059476 A1
(43) Pub. Date: Mar. 6, 2008

(54) Method For Protecting User Privacy in Short Range Communication

(75) Inventor: Ansaf I. Alrabady, Livonia, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/469,928

(22) Filed: Sep. 5, 2006

(51) Int. Cl. G06F 17/30

(52) U.S. Cl. 707/10

(57) ABSTRACT

A method of communicating information between an object and an information collection point via a short-range wireless network while protecting the privacy of a user of the object. Initially, a prompt is sent from the information collection point via the wireless network. The object detects the prompt and establishes a session by generating a random identifier for temporarily identifying the object, and sending the random identifier to the information collection point. The same random identifier is used throughout the session. No information permanently identifying the object is communicated to the information collection point until the information collection point is successfully authenticated to the object. Once this occurs, the object authenticates itself to the information collection point and communicates the information.

### TECHNICAL FIELD

The present invention relates to systems and methods for communicating information between an object and an information collection point via a wireless network. More specifically, the present invention concerns a method of communicating information, e.g., state-of-health information, between an object, e.g., a vehicle, and an information collection point, e.g., a service center, via a short-range wireless network while protecting the privacy, particularly the location privacy, of a user of the object by first establishing a temporary identifier, or address, for the object, and then authenticating the information collection point to the object prior to authenticating the object to the information collection point. More specifically, no information is communicated that permanently identifies the object prior to successfully authenticating the information collection point as a legitimate recipient of that information.

### BACKGROUND OF THE INVENTION

It is often desirable that information be substantially automatically wirelessly communicated between an object, i.e., a device, apparatus, or system, and an information collection point. For example, it is desirable that an automobile or other vehicle substantially automatically, and transparently to its driver, communicate operational, diagnostic, or other state-of-health (SoH) information, whether stored (SSoH) or real-time (RSoH), to a service center as the vehicle moves into communication range with the service center. The service center can then analyze the communicated information and take appropriate action, such as performing maintenance or repair on the vehicle.

The information is communicated to the information collection point via a telematics link using a wireless communication standard, such as wireless fidelity (WiFi) or Bluetooth. WiFi refers to the IEEE 802.11 family of wireless networking standards for wireless local area networks (WLANs). In the present case, the WLAN comprises a wireless network adaptor at the object and an access point (AP) attached to the edge of a wired network at the information collection point, which allows for communication between the object and the information collection point over relatively short distances using, e.g., radio frequency or infrared signals.

It is also desirable, however, to prevent unauthorized access, especially for malicious purposes, via the WLAN to both the object and the information collection point. Thus, prior to the transfer of information, both participants are required to associate and mutually authenticate each other. Unfortunately, this association and mutual authentication can reveal information that identifies the object and, by extension, its user. This identifying information can then be used to track the movements of the object and, by extension, its user, which raises privacy concerns for the user. For example, if a vehicle were simply broadcasting identifying authentication information over the short-range network, then a third-party with an appropriate receiver could receive the information and know the vehicle's, and by extension, the driver's approximate location, thereby violating the driver's location privacy.

### SUMMARY OF THE INVENTION

The present invention provides a method of communicating information between an object and an information collection point via a short-range wireless network while protecting the privacy of a user of the object. In one application, the information is SoH information, the object is an automobile or other vehicle, the information collection point is a service center, and the user is a driver of the vehicle.

Initially, a beacon, or prompt, signal is sent from the information collection point via the wireless network. The object detects the beacon signal and establishes a session by generating a random identifier, or address, for temporarily identifying the object, and sending the random identifier to the information collection point. The same random identifier is used throughout the session. No information permanently identifying the object is communicated to the information collection point until the information collection point is successfully authenticated to the object, thereby establishing that it is a legitimate recipient of the information. Once this occurs, the object authenticates itself, such as with an electronic certificate, to the information collection point and communicates the information.

These and other features of the present invention are discussed in greater detail in the section below titled DESCRIPTION OF THE PREFFERED EMBODIMENT.

### BRIEF DESCRIPTION OF THE DRAWINGS

A preferred embodiment of the present invention is described in detail below with reference to the attached drawing figures, wherein:

FIG. 1 is a system diagram showing components of an exemplary system with which the method of the present invention may be used; and

FIG. 2 is a flowchart of steps involved in practicing a preferred embodiment of the method of the present invention.

### DESCRIPTION OF THE PREFERRED EMBODIMENT

With reference to the figures, an inventive method 100 is herein described, shown, and otherwise disclosed in accordance with a preferred embodiment of the present invention. Broadly, in a system in which operational, diagnostic, or other SoH information is substantially automatically wirelessly communicated over a short distance between an object, e.g., a device, apparatus, or system, and an information collection point, the present invention provides a method 100 of communicating the information while protecting the privacy of a user of the object. For example, in a system in which SoH information is substantially automatically wirelessly communicated between an automobile or other vehicle and a service center, the present invention provides a method 100 of communicating the information while protecting the privacy of a driver of the vehicle.

Though described herein as involving the particular application of communicating information between a vehicle and a service center via WiFi, the present invention is not limited thereto and, instead, is broadly applicable to the communication of information between substantially any object and substantially any information collection point via substantially any short-range wireless communication technology.

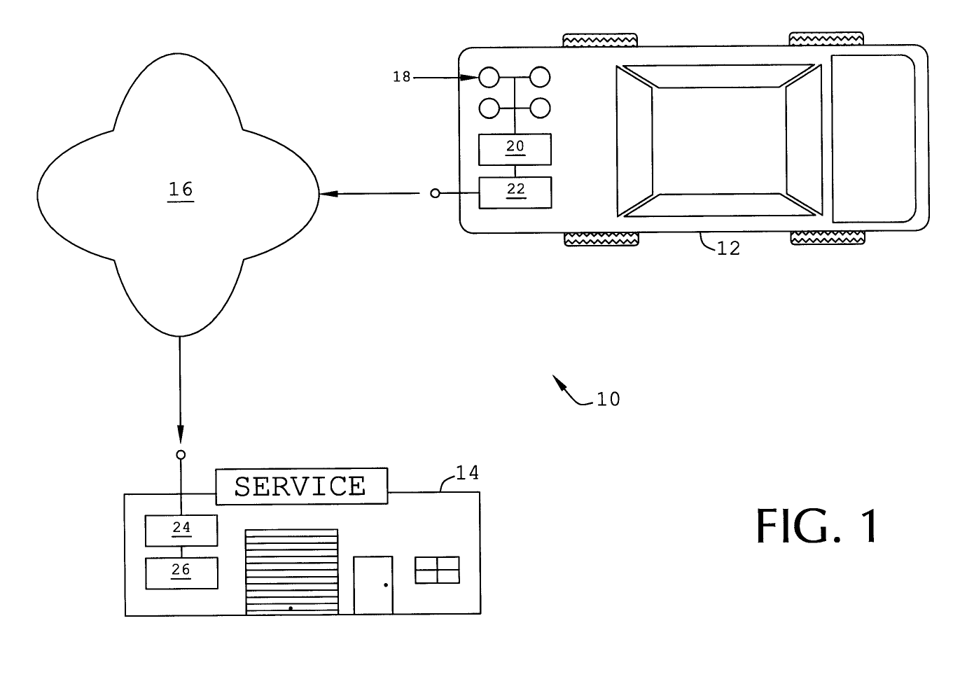

Referring to FIG. 1, an exemplary system 10 is shown with which the method 100 of the present invention may be used. The system 10 broadly comprises the vehicle 12; the service center 14; and the wireless network 16. The vehicle 12 includes one or more sensors 18 for collecting or generating the information to be communicated. The sensors 18 may include substantially any sensor or sensing device operable to collect or generate information concerning an operational, diagnostic, or other SoH parameter of the vehicle 12, such as, for example, temperature sensors, oil pressure sensors, air flow sensors, voltage sensors, current sensors, engine knock sensors, tire pressure sensors, speed sensors, rpm sensors, oxygen sensors, pollution sensors, fuel sensors, fluid level or pressure sensors, and gas production or pressure sensors. The vehicle may also include a processor 20, such as, for example, a data processing module, for receiving the information collected or generated by the sensors 18 and appropriately formatting or otherwise processing the information prior to its communication to the service center 14. The vehicle also includes a wireless network adaptor 22 for accessing the wireless network 16.

The service center 14 includes an AP 24 for accessing the wireless network 16, and a processor 26, such as, for example, a desktop or laptop computer, connected to the AP 24 for receiving and analyzing the information communicated by the vehicle 12.

The wireless network 16 facilitates the establishment of a telematics link, using radio frequency, infrared, or other suitable electromagnetic signals, between the vehicle 12 and the service center 14. As described below, the wireless network is a WiFi network, but, as mentioned, other short-range wireless communication technologies may be used, such as, for example, Bluetooth.

As the vehicle 12 moves into communication range with the service center 14, the vehicle 12 substantially automatically, and substantially transparently to, i.e., without substantial interaction from or even unbeknownst to, the driver, communicates the operational, diagnostic, or other SoH information to the service center 14 via the telematics link. The information may be information that has been previously collected or generated by the sensors 18 and stored, information that is being collected or generated by the sensors 18 in real-time, or a combination thereof. The service center 14 receives the information and analyzes it to determine whether and what maintenance or repair of the vehicle 12 is needed. The service center 14 then takes appropriate action, such as, for example, performing the maintenance or repair.

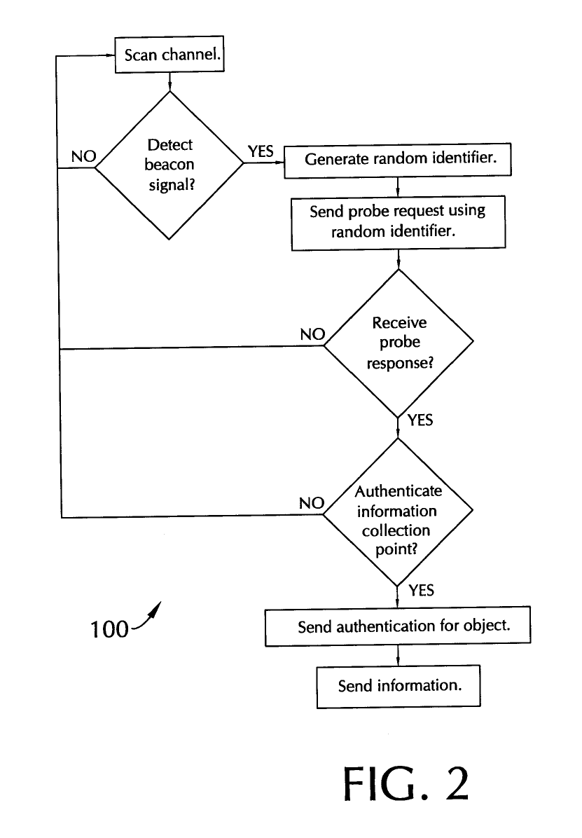

Referring also to FIG. 2, the method 100 of the present invention improves the aforementioned process by protecting the privacy of the driver. Broadly, this is accomplished by first establishing a temporary identifier, or address, for the vehicle 12, and then authenticating the service center 14 to the vehicle 12 prior to authenticating the vehicle 12 to the service center 14. More specifically, no information is communicated that permanently identifies the vehicle 12 prior to successfully authenticating the service center 14 as a legitimate recipient of that information. This is particularly important because the information is communicated over short distances such that mere receipt of the information identifies the approximate location of the vehicle and, by extension, its driver.

In exemplary use and operation, the method 100 may be implemented substantially as follows. The service center 14 continuously or frequently sends a beacon, or prompt, signal, such as, for example, GM SERVICE CENTER, with a known identifier, such as, for example, a Service Set Identifier (SSID). An SSID is a code attached to all packets on a wireless network to identify the packets and the originating devices as part of the network. The vehicle 12 continuously or frequently scans the designated WiFi channel for the SSID. If the vehicle 12 does not detect the SSID, then it does not send a probe request, and, instead, simply continues scanning the WiFi channel. If the vehicle 12 detects the SSID, then it sends a probe request with a randomly generated or selected address, such as, for example, a Media Access Control (MAC) address. A MAC address is a unique identifier attached to most forms of networking equipment. If the vehicle 12 receives a probe response from the service center 14, then it uses the same MAC address for all subsequent communication until the session is terminated. Once association is completed, the vehicle 12 asks the service center 14 to authenticate itself. If authentication is successful, then the vehicle 12 sends its own authentication information, such as, for example, an electronic certificate, to the service center 14 to allow the service center 14 to authenticate the vehicle 12. Thereafter, the vehicle 12 communicates the SoH information to the service center 14.

Although the invention has been described with reference to the preferred embodiments illustrated in the attached drawings, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A method of communicating information between an object and an information collection point via a wireless network, the method comprising the steps of:
(a) sending a prompt from the information collection point via the wireless network;
(b) detecting the prompt at the object;
(c) establishing a session by responding to the detected prompt by generating a random identifier for temporarily identifying the object, and sending the random identifier to the information collection point; and
(d) successfully authenticating the information collection point to the object prior to authenticating the object to the information collection point.

2. The method as set forth in claim 1, wherein the method is performed substantially automatically and without substantial interaction by a user of the object.

3. The method as set forth in claim 1, wherein the information includes one or more state-of-health parameters.

4. The method as set forth in claim 1, wherein the object includes one or more sensors for providing the one or more state-of-health parameters.

5. The method as set forth in claim 1, wherein the object is an automobile and the information collection point is a service center.

6. The method as set forth in claim 1, further including, in step (c), using the same random identifier throughout the session.

7. The method as set forth in claim 1, further including the step of—
(e) communicating the information to the information collection point upon successful authentication of the information collection point to the object and of the object to the information collection point.

8. A method of communicating information, including one or more state-of-health parameters, between an object and an information collection point via a short-range wireless network, the method comprising the steps of:
(a) sending a prompt from the information collection point via the short-range wireless network;
(b) detecting the prompt at the object;
(c) establishing a session by responding to the detected prompt by generating a random identifier for temporarily identifying the object, and sending the random identifier to the information collection point;
(d) using the same random identifier throughout the session;
(e) successfully authenticating the information collection point to the object prior to authenticating the object to the information collection point; and
(f) communicating the information, including the one or more state-of-health parameters, to the information collection point upon successful authentication of the information collection point to the object and of the object to the information collection point.

9. The method as set forth in claim 8, wherein the method is performed substantially automatically and without substantial interaction by a user of the object.

10. The method as set forth in claim 8, wherein the object includes one or more sensors for providing the one or more state-of-health parameters.

11. The method as set forth in claim 8, wherein the object is a vehicle and the information collection point is a service center.

12. A method of communicating information between a vehicle and a service center via a short-range wireless network, wherein the information includes one or more state-of-health parameters provided by one or more sensors on the vehicle, the method comprising the steps of:
(a) sending a prompt from the service center via the short-range wireless network;
(b) detecting the prompt at the vehicle;
(c) establishing a session by responding to the detected prompt by generating a random identifier for temporarily identifying the vehicle, and sending the random identifier to the service center;
(d) successfully authenticating the service center to the vehicle prior to authenticating the vehicle to the service center; and
(e) communicating the information, including the one or more state-of-health parameters provided by the one or more sensors on the vehicle, to the service center upon successful authentication of the service center to the vehicle and of the vehicle to the service center,
wherein the method is performed substantially automatically and without substantial interaction by a driver of the vehicle.

13. The method as set forth in claim 12, further including, in step (c), using the same random identifier throughout the session.

14. A method of communicating state-of-health information between an object and an information collection point via a wireless network, the method comprising the steps, in order, of:
(a) identifying the object to the information collection point using a temporary identifier;
(b) authenticating the information collection point to the object;
(c) authenticating the object to the information collection point by identifying the object to the information collection point using a permanent identifier; and
(d) communicating the state-of-health information to the information collection point.

15. The method as set forth in claim 14, wherein the method is performed substantially automatically and without substantial interaction by a user of the object.

16. The method as set forth in claim 14, wherein the state-of-health information is collected by one or more sensors on the object.

17. The method as set forth in claim 14, wherein the object is an automobile and the information collection point is a service center.

18. The method as set forth in claim 14, further including, in step (a), using the same temporary identifier throughout the session.
